(19) United States
(12) Patent Application Publication
(10) Pub. No.: US 2012/0090871 A1
(43) Pub. Date: Apr. 19, 2012

(54) HYDROUS WATER ABSORBENT POLYMER DISPERSED ULTRAVIOLET CURABLE RESIN COMPOSITION, INSULATED ELECTRIC WIRE USING THE SAME, METHOD FOR PRODUCING THE WIRE, AND COAXIAL CABLE

(75) Inventors: Yoshihisa KATO, Takahagi (JP); Tomiya Abe, Hitachi (JP); Takao Miwa, Hitachinaka (JP); Osamu Seya, Hitachi (JP)

(73) Assignees: Hitachi Cable Fine-Tech, Ltd.; Hitachi Cable, Ltd.

(21) Appl. No.: 13/099,634

(22) Filed: May 3, 2011

(30) Foreign Application Priority Data
Oct. 14, 2010 (JP) 2010-231544

(51) Int. Cl. H01B 7/18; H01B 3/30; B05D 3/02; H01B 13/06; B05D 3/06; C08J 3/28; H01B 7/00

(52) U.S. Cl. 174/102 R; 522/33; 174/110 SR; 174/120 SR; 427/521

(57) ABSTRACT

A hydrous water absorbent polymer dispersed ultraviolet curable resin composition includes an ultraviolet curable resin composition, and a hydrous water absorbent polymer swollen by water beforehand, and dispersed in the ultraviolet curable resin composition so that the hydrous water absorbent polymer dispersed ultraviolet curable resin composition has a moisture content of not less than 50 percent. The water absorption rate of the ultraviolet curable resin composition is not more than 2 percent.

The present application is based on Japanese patent application No. 2010-231544 filed on Oct. 14, 2010, the entire contents of which are incorporated herein by reference.

### BACKGROUND OF THE INVENTION

1. Field of the Invention

This invention relates to a hydrous water absorbent polymer dispersed ultraviolet curable resin composition, an insulated electric wire using the same, a method for producing the insulated electric wire, and a coaxial cable.

2. Description of the Related Art

In recent years, with continuing miniaturization and high density packaging of medical precision electronic equipment and communications equipment, electric wires/cables to be used therein have also been designed to be increasingly thinned in diameter. Further, for signal lines and the like, there has been a notable tendency to demand higher speed transmission signals, and it is therefore desired that an insulation layer for electric wires to be used in the signal lines is thin and has as low a dielectric constant as possible so that transmission signals are thereby designed to be high speed.

This insulation layer for electric wires uses a foam low dielectric constant insulating material such as polyethylene, fluororesin, or the like. The known method to form this foam insulating layer is the wrapping of a prefoamed film around a conductor, or the extrusion coating of a melt of the foam insulating material onto the conductor, especially the extrusion coating is widely used.

The foaming method is broadly divided into physically and chemically foaming methods. The physically foaming method is to inject into a melted resin a volatile foaming liquid such as liquid CFC to exert its evaporating pressure to thereby cause the melted resin to foam, or to inject a foam gas, such as nitrogen gas, carbon dioxide, or the like, directly into a melted resin in an extruder, to thereby produce uniformly distributed cellular micro closed pores in the melted resin.

On the other hand, the chemically foaming method is to disperse and mix a foaming agent in a melted resin, mold the melted resin and subsequently heat it to thereby decompose the foaming agent, produce a gas, and cause the melted resin to foam.

Thin coating methods, which are alternatives to the previously mentioned extrusion coating, are thermally curable resin coating as exemplified by enameled wires, ultraviolet curable resin coating of optical fibers, or the like.

For example, related arts to the invention may be JP-A-58-62024, JP-A-57-170725, JP-A-3-185063, JP-A-11-5863, JP-A-11-100457, and JP-B-3717942.

### SUMMARY OF THE INVENTION

However, the physically foaming method by injecting the volatile foaming liquid into the melted resin has the limits of thin molding due to strong evaporating pressure, and difficulty in micro bubble formation or homogenous formation. Also, there is the problem of slow speed of injecting the volatile foaming liquid, therefore difficulty in high speed producing, and poor productivity.

The physically foaming method by injecting the foam gas directly into the melted resin in an extruder has the limits of extrusion thin in diameter or thickness, and the problem of special facilities or techniques required for safety, therefore poor productivity or high producing cost.

The physically foaming method by using CFC, butane, carbon dioxide, or the like has the problem of high environmental load, and the foaming agent used for the chemical foaming has the problem of high cost.

On the other hand, the chemically foaming method has the problem that because by kneading, dispersing and mixing the foaming agent in the melted resin beforehand, the melted resin is molded and subsequently heated to thereby decompose the foaming agent to produce the foam gas, the melted resin molding temperature has to be held at a lower temperature than the foaming agent decomposition temperature. Further, there is another problem that a thin wire diameter tends to cause the wire to be broken by resin pressure of the extrusion coating, and therefore makes high speed transmission signals difficult.

Accordingly, it is an object of the present invention to provide a hydrous water absorbent polymer dispersed ultraviolet curable resin composition, which is suitable for a material for forming a low dielectric constant porous thin film layer having a high porosity and homogeneous micro pores, and being thinnable in diameter or thickness, an insulated electric wire using the hydrous water absorbent polymer dispersed ultraviolet curable resin composition and a method for producing the insulated electric wire, and a coaxial cable.
(1) According to one embodiment of the invention, a hydrous water absorbent polymer dispersed ultraviolet curable resin composition comprises:

an ultraviolet curable resin composition; and

a hydrous water absorbent polymer swollen by water beforehand, and dispersed in the ultraviolet curable resin composition so that the hydrous water absorbent polymer dispersed ultraviolet curable resin composition has a moisture content of not less than 50 percent,

wherein a water absorption rate of the ultraviolet curable resin composition is not more than 2 percent.

In the above embodiment (1) of the invention, the following modifications and changes can be made.

(i) The ultraviolet curable resin composition comprises a polyether based urethane (meth)acrylate oligomer having a water absorption rate of not more than 2 percent, a hydrophobic monomer, and a photoinitiator, and the ultraviolet curable resin composition comprises the oligomer of 50 to 80 weight percent, the hydrophobic monomer of 20 to 50 weight percent, and the photoinitiator of 1 to 10 weight percent, and the ultraviolet curable resin composition has a viscosity of 1 to 10 Pa·s at 25 degrees Celsius.

(ii) The hydrous water absorbent polymer dispersed ultraviolet curable resin composition further comprises a non-ionic surfactant added to the ultraviolet curable resin composition.
(2) According to another embodiment of the invention, an insulated electric wire comprises:

a conductor; and

an insulating layer comprising the hydrous water absorbent polymer dispersed ultraviolet curable resin composition according to the embodiment (1), which coats a perimeter of the conductor, is cured, and subsequently heated to remove moisture from the resin composition.

In the above embodiment (2) of the invention, the following modifications and changes can be made.

(iii) The insulating layer is not more than 200 μm in thickness, and is 50 to 70 percent in porosity rate.

(iv) A multilayer sheathed cable comprises the insulated electric wire, and a skin layer on a periphery of the insulated electric wire.
(3) According to another embodiment of the invention, a method for producing an insulated electric wire comprises:

coating a perimeter of a conductor with the hydrous water absorbent polymer dispersed ultraviolet curable resin composition according to the embodiment (1);

curing the resin composition to form an insulating layer; and

subsequently heating the resin composition to remove moisture from the hydrous water absorbent polymer in the insulating layer, to thereby form pores in the insulating layer.

In the above embodiment (3) of the invention, the following modifications and changes can be made.

(v) The heating comprises a microwave heating.
(4) According to another embodiment of the invention, a coaxial cable comprises:

the insulated electric wire according to the embodiment (2); and

a shielding member on a periphery of the insulated electric wire, the shielding member comprising a metal.

### Points of the Invention

According to one embodiment of the invention, a hydrous water absorbent polymer dispersed ultraviolet curable resin composition is prepared such that it has a moisture content of not less than 50 percent so as to have a lower dielectric constant when being made porous by dehydration thereof. Also, the hydrous water absorbent polymer dispersed ultraviolet curable resin composition is prepared such that it includes an ultraviolet curable resin composition with a water absorption rate of not more than 2 percent. This is because, at the water absorption rate of more than 2 percent, when the hydrous water absorbent polymer (which is swollen with water in advance) is dispersed to have the hydrous water absorbent polymer dispersed ultraviolet curable resin composition with a moisture content of not less than 50 percent, the melted resin component tends to dissolve into the hydrous water absorbent polymer and the water in the hydrous water absorbent polymer tends to dissolve into the melted resin component, so that the hydrous water absorbent polymer is difficult to disperse separately from each other, whereby the sea island structure may be reversed to lower the porosity rate and deteriorate the uniformity of pores (voids).

### BRIEF DESCRIPTION OF THE DRAWINGS

The preferred embodiments according to the invention will be explained below referring to the drawings, wherein:

FIG. 1 is a schematic transverse cross-sectional view showing a porous film sheathed electric wire according to the invention;

FIG. 2 is a schematic cross-sectional view showing a multilayer sheathed cable using the porous film sheathed electric wire according to the invention;

FIG. 3 is a schematic cross-sectional view showing a coaxial cable using the porous film sheathed electric wire according to the invention;

FIG. 4 is a schematic cross-sectional view showing another example of a coaxial cable using the porous film sheathed electric wire according to the invention;

FIG. 5 is a 200 times magnified photograph showing a cross section of a film produced from a hydrous water absorbent polymer containing resin composition in a typical example according to the invention; and

FIG. 6 is a 200 times magnified photograph showing a cross section of a film produced by adding a surfactant to a hydrous water absorbent polymer containing resin composition in a typical example according to the invention.

### DETAILED DESCRIPTION OF THE PREFERRED EMBODIMENTS

Below are described the preferred embodiments according to the invention, in conjunction with the accompanying drawings.

### First Embodiment

Hydrous Water Absorbent Polymer Dispersed Ultraviolet Curable Resin Composition

A hydrous water absorbent polymer dispersed ultraviolet curable resin composition in the first embodiment has a moisture content of not less than 50 percent, by dispersing into an ultraviolet curable resin composition a hydrous water absorbent polymer, which has absorbed and been swollen by water beforehand.

Water Absorbent Polymer

The water absorbent polymer refers to a high molecular substance, which soaks up water very well, and because of its strong retention of moisture, does not expel the water soaked up even if slight pressure is exerted thereon. The hydrous water absorbent polymer refers to this water absorbent polymer which has absorbed water. It is preferred that the water absorbent polymer contains no sodium, and absorbs not less than 20 g/g water. As a typical example of the water absorbent polymer, there is polyalkylenoxide based resin.

The reason for no sodium being contained in the water absorbent polymer is because it tends to be a factor in reducing electrical insulation. The amount of water to be absorbed refers to an amount (g) of water absorbed per 1 g water absorbent polymer. The reason for the amount of water absorbed being not less than 20 g/g is because when the amount of water absorbed is smaller than 20 g/g, the pore forming efficiency lowers, and much use of the water absorbent polymer is required.

Water Absorption Rate

The ultraviolet curable resin composition may, if cured by ultraviolet rays, be selected from resin compositions of each kind, such as urethane-, silicon-, fluorine-, epoxy-, polyester-, and polycarbonate-based resin compositions, but it is preferred that the resin composition is hydrophobized to have a water absorption rate of not more than 2 percent. This water absorption rate is the value obtained in conformity with the A method of JIS K7209 “Testing methods for water absorption rates and boiling water absorption rates of plastics.” It should be noted, however, that the thickness of its sample is set at 210±20 μm.

The reason for adjusting the water absorption rate of the ultraviolet curable resin composition to not more than 2 percent is because when at water absorption rates of higher than 2 percent the hydrous water absorbent polymer is dispersed to permit a moisture content of not less than 50 percent, the melted resin component tends to dissolve into the hydrous water absorbent polymer, while the water in the hydrous water absorbent polymer tends to dissolve into the melted resin component, so that the hydrous water absorbent polymer is difficult to disperse in closed pore form, and so that the sea island structure tends to be reversed.

Moisture Content

The reason for adjusting the moisture content of the hydrous water absorbent polymer dispersed ultraviolet curable resin composition to not less than 50 percent is because of having the low dielectric constant effect by being made porous. The suitable dielectric constant of the ultraviolet curable resin composition is not more than 4, preferably not more than 3. Here, the moisture content is the proportion of water occupied in the hydrous water absorbent polymer dispersed ultraviolet curable resin composition.

Viscosity

One suitable example of the ultraviolet curable resin composition consists of a polyether based urethane (meth)acrylate oligomer having a water absorption rate of not more than 2 percent, a hydrophobic monomer, and a photoinitiator. In that resin composition, the oligomer is adjusted to from 50 to 80 weight percent, the hydrophobic monomer is adjusted to from 20 to 50 weight percent, and the photoinitiator is adjusted to from 1 to 10 weight percent, and the suitable viscosity at 25 degrees Celsius of that resin composition ranges from 1 to 10 Pa·s.

The reason for using the polyether based urethane (meth)acrylate oligomer having a water absorption rate of not more than 2 percent is because of producing the ultraviolet curable resin composition having a water absorption rate of not more than 2 percent, and further being excellent in toughness and flexibility, not likely to crack when bent.

It is preferred that the molecular weight of the polyether based urethane(meth)acrylate oligomer is from 1000 to 3000. The polyether based urethane(meth)acrylate oligomer having a molecular weight of smaller than 1000 is hard to be flexible, and is therefore not preferable. On the other hand, the polyether based urethane(meth)acrylate oligomer having a molecular weight of greater than 3000 is high in viscosity, poor in handling, and poor in dispersion of the hydrous water absorbent polymer, and is therefore not preferable.

The reason for using the hydrophobic monomer is because of reducing the water absorption rate of the ultraviolet curable resin composition. The hydrophobic monomer is not particularly limited, but is exemplified by cyclopentanyl(meth)acrylate, isobornyl(meth)acrylate, dicyclopentanyl di(meth)acrylate, etc. The photoinitiator is also not particularly specified, but may use a general photoinitiator such as 1-hydroxy cyclohexyl phenyl ketone, etc.

The reason for setting the oligomer ratio at from 50 to 80 weight percent is because when the oligomer ratio is less than 50 weight percent, there is the problem that the hydrous water absorbent polymer dispersed ultraviolet curable resin composition tends to crack or be fragile due to being bent, due to thermal shock or the like, and because when the oligomer ratio is more than 80 weight percent, on the other hand, there is the problem that the ultraviolet curable resin composition is high in viscosity, and therefore poor in handling or in dispersion of the hydrous water absorbent polymer.

The reason for setting the hydrophobic monomer ratio at from 20 to 50 weight percent is because when the hydrophobic monomer ratio is less than 20 weight percent, the ultraviolet curable resin composition is high in viscosity, and therefore significantly poor in porous layer formation by dispersion of the hydrous water absorbent polymer, and because when the hydrophobic monomer ratio is more than 50 weight percent, on the other hand, there is the problem that it is difficult to obtain the balance of the property such as the flexibility, the mechanical property, or the like.

The reason for setting the photoinitiator at from 1 to 10 weight percent is because when the photoinitiator ratio is less than 1 weight percent there is the problem that the ultraviolet curable resin composition is poor in curability, and because when the photoinitiator ratio is more than 10 weight percent, on the other hand, there tends to arise the problem of having no additive curing effect, and degrading the mechanical property.

The reason for setting the viscosity of the ultraviolet curable resin composition at from 1 to 10 Pa·s (at 25 degrees Celsius) is because when the viscosity is lower than 1 Pa·s, there tends to arise the problem of difficulty forming film coating thickness, and because when the viscosity is higher than 10 Pa·s, the hydrous water absorbent polymer is difficult to disperse, and therefore difficult to form the porous layer, and it is necessary to increase the heating temperature so as to reduce the viscosity. It is also because there is the problem that when the heating temperature is high, moisture tends to be stripped away from the hydrous water absorbent polymer, and when the temperature is lowered, dew condensation tends to occur on the inner walls in the container.

A non-ionic surfactant is suitably added to the ultraviolet curable resin composition. The reason for adding this non-ionic surfactant is because of enhancing the dispersion of the hydrous water absorbent polymer, and enhancing the moisture content.

The reason for the surfactant being non-ionic is because of preventing degradation of the electrical insulating property. The non-ionic surfactant is not particularly limited, but is exemplified by fluorine based surfactants, silicon based surfactants, polyoxyethylene alkyl ethers, polyoxyethylene alkyl phenol ethers, alkyl glucosides, polyoxyethylene fatty acid esters, sucrose fatty acid esters, sorbitan fatty acid esters, polyoxyethylene sorbitan fatty acid esters, fatty acid alkanolamides, etc. It is preferred that the additive amount of the non-ionic surfactant is from 0.05 to 3 weight percent.

The additive amount of the non-ionic surfactant being less than 0.05 weight percent is difficult to have the hydrous water absorbent polymer dispersing effect and is therefore not preferable. On the other hand, the additive amount of the non-ionic surfactant being more than 3 weight percent has the problem of having no additive dispersing effect, but adversely degrading the dispersion and is therefore not preferable.

The reason for dispersing the water absorbed and swollen water absorbent polymer is that the water absorbed, swollen and gelled water absorbent polymer contains much water, and when stirred and dispersed, tends to be dispersed in closed and spherical pore form because of immiscibility of the water and the ultraviolet curable resin composition. This allows pores resulting from dehydration after curing to be formed in substantially spherical shape, and be therefore resistant to collapse.

It is preferred to set the dispersion diameter of the hydrous water absorbent polymer at not more than 50 μm. It is because when this dispersion diameter is more than 50 μm, the outside coating diameter tends to vary, so that the coating is difficult to thin, and also the collapse tends to occur.

It is preferred to set the proportion of the water in the hydrous water absorbent polymer at not less than 90 percent. It is because when the proportion of the water is less than 90 percent, there is the problem that moisture tends to be absorbed after dehydration by the proportion of the water absorbent polymer in the ultraviolet curable resin composition increasing with increasing water content.

### Second Embodiment

A porous substance (foam) derived from the hydrous water absorbent polymer dispersed ultraviolet curable resin composition may be applied to cushioning materials, shock absorbing films (sheets), light reflectors, sheathed electric wires, cables, etc. Also, since the hydrous water absorbent polymer dispersed ultraviolet curable resin composition is liquid, the porous layer may be formed on deformed object surface. Incidentally, the hydrous water absorbent polymer dispersed ultraviolet curable resin composition may be used by adding thereto a dispersing agent, leveling agent, coupling agent, coloring agent, fire retardant, antioxidant, electrical insulation enhancer, filler, etc.

Insulated Electric Wire and Cables

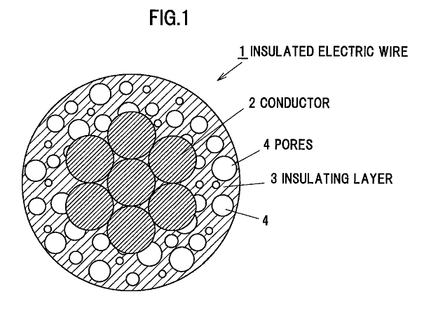

Referring to FIGS. 1 to 4, an insulated electric wire and cables using the hydrous water absorbent polymer dispersed ultraviolet curable resin composition as configured above are described below.

Referring to FIG. 1, an insulated electric wire 1 includes a conductor 2 configured as stranded metal wires such as copper wires, and an insulating layer 3 formed to coat the perimeter of the conductor 2. This insulating layer 3 is configured as a porous layer. That is, the insulating layer 3 is formed with a plurality of pores 4 therein by, after coating and curing of the hydrous water absorbent polymer dispersed ultraviolet curable resin composition around the conductor 2, heating the cured resin composition to remove moisture from the hydrous water absorbent polymer.

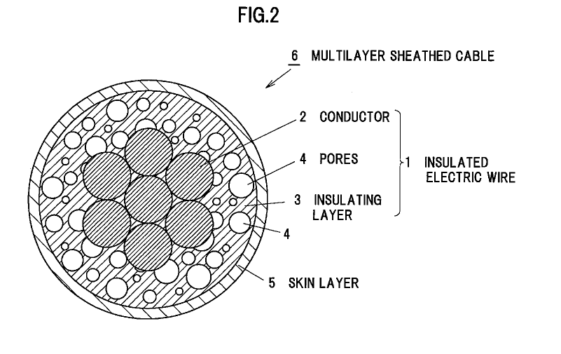

Referring to FIG. 2, a schematic cross section of a multilayer sheathed cable 6 is shown. The multilayer sheathed cable 6 is produced by forming a skin layer 5 to cover the perimeter of the insulated electric wire 1 shown in FIG. 1. The method used to form the skin layer 5 is the wrapping of a film formed of the hydrous water absorbent polymer dispersed ultraviolet curable resin composition around the conductor 2, or the extrusion coating and molding of a melt of the hydrous water absorbent polymer dispersed ultraviolet curable resin composition onto the conductor 2.

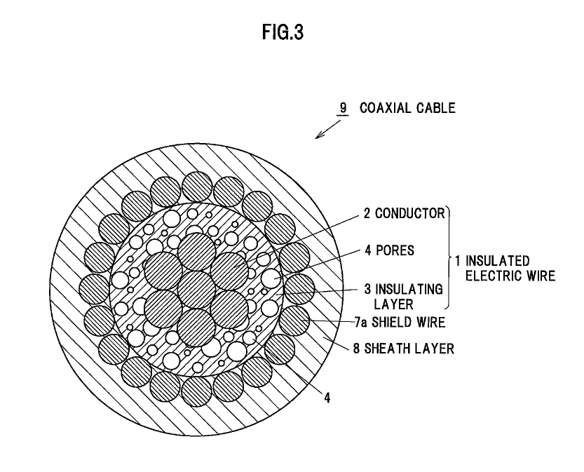

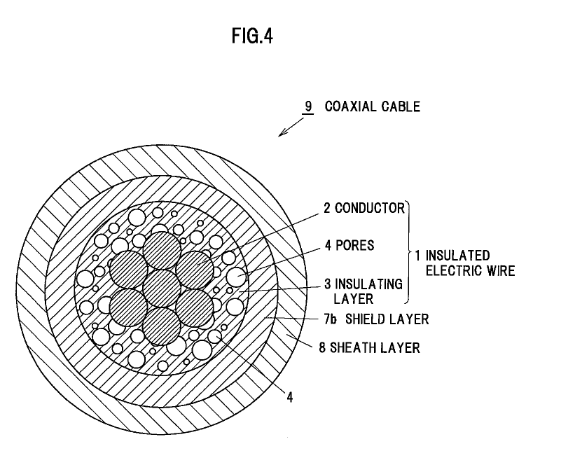

Referring to FIG. 3, a schematic cross section of a coaxial cable 9 is shown. The coaxial cable 9 is produced by forming a shield wire 7a to serve as a metallic shield to cover the perimeter of the insulated electric wire 1 shown in FIG. 1, and by forming a sheath layer 8 to cover the perimeter of that shield wire 7a. Incidentally, referring to FIG. 4, another example of the coaxial cable 9 is shown. The coaxial cable 9 may, in place of the shield wire 7a, be formed with a shield layer 7b which serves as a metal containing synthetic resin shield to cover the insulating layer 3.

Insulating Layer 3

It is preferred that the thickness of the insulating layer 3 of the insulated electric wire 1 or the cable 6 or 9 shown in FIGS. 1 to 4 is not more than 200 μm. It is preferred that the porosity of the insulating layer 3 is from 50 to 70 percent.

The reason for setting the thickness of the insulating layer 3 at not more than 200 μm is because the insulating layer 3 thicker than 200 μm has no merit of thinning the coating, and lowers the efficiency of ultraviolet curing. The reason for setting the porosity of the insulating layer 3 at from 50 to 70 percent is because when the porosity is lower than 50 percent, there tends to arise the problem that the low dielectric constant porous layer effect is small, and because when the porosity is higher than 70 percent, there tends to arise the problem that the hydrous water absorbent polymer when dispersed tends to disperse unstably, and also that the coating is poor.

Microwave heating is suitably used for thermal dehydration of water in the water absorbent polymer which has absorbed water. The reason for using this microwave heating is because microwaves allow efficient pore 4 formation by heating the water rapidly to allow short thermal dehydration without affecting the water absorbent polymer or the surrounding resin. Use of a waveguide microwave heating furnace allows continuous thermal dehydration. This heating may use a combination of the waveguide microwave heating furnace and a general heating furnace.

Also, the reason for the thermal dehydration after cross link curing is because of preventing the reduction of the porosity due to volume contraction resulting from the dehydration, and because of preventing variations in film thickness or outside diameter, to allow stable electric wire or cable production. Further, because it is possible to form the insulating layer 3 having the pores 4 beforehand, there is no need to cause it to foam. This allows stable insulated electric wire or cable production without any deterioration in the adhesion between the conductor 2 and the insulating layer 3 due to expansion or separation therebetween which tends to be caused in conventional gas foaming by gas injection or foaming agents.

### EXAMPLES

The hydrous water absorbent polymer dispersed ultraviolet curable resin composition is further described below, by way of Examples of the invention and a Comparative example.

Four ultraviolet curable resin compositions A to D in Examples 1 to 3 and Comparative example 1 below are prepared and compared.

### Example 1

The ultraviolet curable resin composition A is prepared by adding, to 100 parts by weight (56.1 weight percent) of urethane acrylate oligomer (GX98871 from DAI-ICHI KOGYO SEIYAKU CO., LTD.) having a water absorption rate of 1.1 percent, 70 parts by weight (39.2 weight percent) of hydrophobic cyclopentanyl methacrylate monomer (FA-513M from Hitachi Chemical Co., Ltd.), 3 parts by weight (1.7 weight percent) of 1-hydroxy cyclohexyl phenyl ketone photoinitiator (IRGACURE® 184 from CIBA SPECIALTY CHEMICALS), 5 parts by weight (2.8 weight percent) of 2,4,6-trimethylbenzoyl diphenyl phosphine oxide (DAROCUR® TPO from CIBA SPECIALTY CHEMICALS), 0.2 parts by weight (0.1 weight percent) of hydroquinone stabilizer, and 0.2 parts by weight (0.1 weight percent) of 2,2-tiodiethylene bis[3-(3,5-di-t-butyl-4-hydroxyphenyl)propionate] antioxidant (IRGANOX® 1035 from CIBA SPECIALTY CHEMICALS).

For this resin composition A, the viscosity measured is 2100 mPa·s (at 25 degrees Celsius). This resin composition A is heated to 50 degrees Celsius, and a 100 mm wide and 200 mm long coating film thereof is formed on a glass sheet by using a 15 MIL blade, and 500 mJ/cm² ultraviolet cured in a nitrogen atmosphere by using an ultraviolet irradiation conveyer system. This results in the film being approximately 200 μm thick. The water absorption rate thereof then measured in conformity with the A method of JIS K7209 is 1.5 percent.

### Example 2

The ultraviolet curable resin composition B is prepared by adding, to 100 parts by weight (53.1 weight percent) of urethane acrylate oligomer (R1240 from DAI-ICHI KOGYO SEIYAKU CO., LTD.) having a water absorption rate of 1.8 percent, 80 parts by weight (42.5 weight percent) of hydrophobic cyclopentanyl methacrylate monomer (FA-513M from Hitachi Chemical Co., Ltd.), 3 parts by weight (1.6 weight percent) of 1-hydroxy cyclohexyl phenyl ketone photoinitiator (IRGACURE® 184 from CIBA SPECIALTY CHEMICALS), 5 parts by weight (2.6 weight percent) of 2,4,6-trimethylbenzoyl diphenyl phosphine oxide (DAROCUR® TPO from CIBA SPECIALTY CHEMICALS), 0.2 parts by weight (0.1 weight percent) of hydroquinone stabilizer, and 0.2 parts by weight (0.1 weight percent) of 2,2-tiodiethylene bis[3-(3,5-di-t-butyl-4-hydroxyphenyl)propionate] antioxidant (IRGANOX® 1035 from CIBA SPECIALTY CHEMICALS).

For the resin composition B, the viscosity measured is 3200 mPa·s (at 25 degrees Celsius). For a film of the resin composition B produced in the same way as the above resin composition A film, the water absorption rate measured is 2.0 percent.

### Example 3

The ultraviolet curable resin composition C is prepared by adding, to 100 parts by weight (56.1 weight percent) of urethane acrylate oligomer (LPVC-1 from Negami Chemical Industrial Co., Ltd.) having a water absorption rate of 1.7 percent, 70 parts by weight (39.2 weight percent) of hydrophobic cyclopentanyl methacrylate monomer (FA-513M from Hitachi Chemical Co., Ltd.), 3 parts by weight (1.7 weight percent) of 1-hydroxy cyclohexyl phenyl ketone photoinitiator (IRGACURE® 184 from CIBA SPECIALTY CHEMICALS), 5 parts by weight (2.8 weight percent) of 2,4,6-trimethylbenzoyl diphenyl phosphine oxide (DAROCUR® TPO from CIBA SPECIALTY CHEMICALS), 0.2 parts by weight (0.1 weight percent) of hydroquinone stabilizer, and 0.2 parts by weight (0.1 weight percent) of 2,2-tiodiethylene bis[3-(3,5-di-t-butyl-4-hydroxyphenyl)propionate] antioxidant (IRGANOX® 1035 from CIBA SPECIALTY CHEMICALS).

For the resin composition C, the viscosity measured is 11000 mPa·s (at 25 degrees Celsius). For a film of the resin composition C produced in the same way as the above resin composition A film, the water absorption rate measured is 1.9 percent.

### Comparative Example 1

The ultraviolet curable resin composition D is prepared by adding, to 100 parts by weight (63.1 weight percent) of urethane acrylate oligomer (M-1600 from TOAGOSEI Co., Ltd.) having a water absorption rate of 2.4 percent, 50 parts by weight (31.6 weight percent) of hydrophobic cyclopentanyl methacrylate monomer (FA-513M from Hitachi Chemical Co., Ltd.), 3 parts by weight (1.9 weight percent) of 1-hydroxy cyclohexyl phenyl ketone photoinitiator (IRGACURE® 184 from CIBA SPECIALTY CHEMICALS), 5 parts by weight (3.2 weight percent) of 2,4,6-trimethylbenzoyl diphenyl phosphine oxide (DAROCUR® TPO from CIBA SPECIALTY CHEMICALS), 0.2 parts by weight (0.1 weight percent) of hydroquinone stabilizer, and 0.2 parts by weight (0.1 weight percent) of 2,2-tiodiethylene bis[3-(3,5-di-t-butyl-4-hydroxyphenyl)propionate] antioxidant (IRGANOX® 1035 from CIBA SPECIALTY CHEMICALS).

For the resin composition D, the viscosity measured is 3500 mPa·s (at 25 degrees Celsius). For a film of the resin composition D produced in the same way as the above resin composition A film, the water absorption rate measured is 2.8 percent.

Hydrous Water Absorbent Polymer

A hydrous water absorbent polymer is prepared by mixing a 50 μm average particle diameter water absorbent polymer (AQUACOKE® TWP-PF from Sumitomo Seika Chemicals Co., Ltd.) with distilled water at a ratio of 1:31, and leaving it to stand for 24 hours. This hydrous water absorbent polymer is thereafter pulverized once at a pressure of 130 MPa by using a high pressure homogenizer (PANDA 2K TYPE from Niro Soavi Inc.).

Hydrous Water Absorbent Polymer Dispersed Ultraviolet Curable Resin Composition

This hydrous water absorbent polymer pulverized is added to the resin compositions A to D in Examples 1 to 3 and Comparative example 1 above, heated at 50 degrees Celsius, stirred and dispersed at 600 rpm for 30 minutes. This results in hydrous water absorbent polymer dispersed ultraviolet curable resin compositions. For the resultant resin compositions, the moisture content for being moldable into a film for serving as a foam insulating layer is tested. Its results are shown in Table 1 below.

Film Moldability

For the hydrous water absorbent polymer dispersed ultraviolet curable resin compositions heated at 50 degrees Celsius, a 100 mm wide and 200 mm long coating film thereof is formed on a glass sheet by using a 15 MIL blade, and 500 mJ/cm² ultraviolet cured in a nitrogen atmosphere by using an ultraviolet irradiation conveyer system, to test whether an approximately 200 μm thick film is produced.

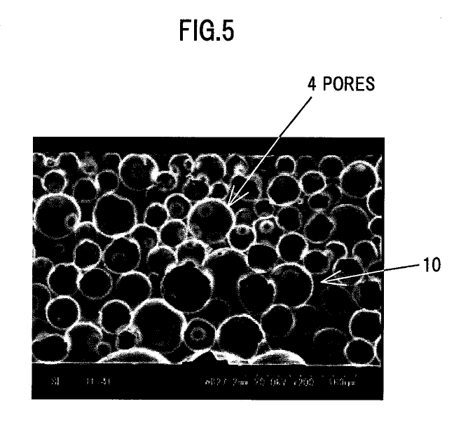

Referring to FIG. 5, there is shown a photograph of a cross section of a film formed of the hydrous water absorbent polymer dispersed ultraviolet curable resin composition produced by adding the hydrous water absorbent polymer to the resin composition A in Example 1, and dehydrated at 100 degrees Celsius for 1 hour. The diameter of a plurality of pores 4 formed is from 20 to 50 μm. Incidentally, numeral 10 in FIG. 5 denotes a hardened material of the hydrous water absorbent polymer dispersed ultraviolet curable resin composition.

TABLE 1

| | | | | | Comparative |
|---|---|---|---|---|---|
| | | Example | | | example |
| | | 1 | 2 | 3 | 1 |
| Resin | Sample No. | A | B | C | D |
| composition | Viscosity (mPa · s) | 2100 | 3200 | 11000 | 3500 |
| | at 25° C. | | | | |
| | Water absorption | 1.5 | 2.0 | 1.9 | 2.8 |
| | rate (%) | | | | |

| | | | | |
|---|---|---|---|---|
| Maximum moisture content (%) | 72 | 68 | 60 | 55 |

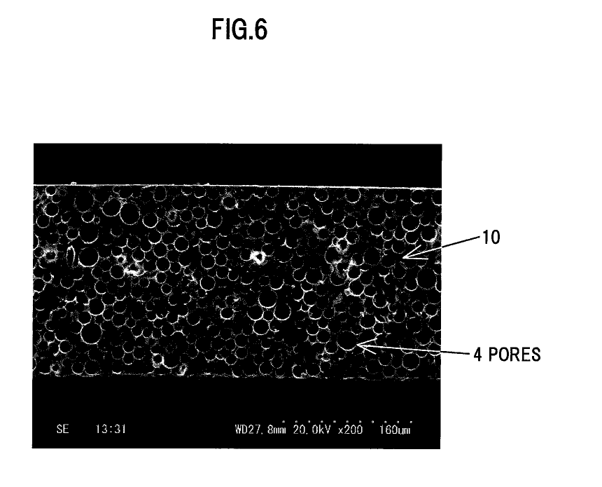

1 part by weight of non-ionic α-monoisostearyl glyseryl ether surfactant (PENETOL GE-IS from Kao Corporation) is added to the resin composition A in Example 1, and as with Example 1, the hydrous water absorbent polymer is added thereto, followed by molding into a film having the maximum moisture content of 72 percent. The resultant film is dehydrated at 100 degrees Celsius for 1 hour. A photograph of a cross section of that film is shown in FIG. 6. The diameter of a plurality of pores 4 formed is from 5 to 25 μm. Incidentally, numeral 10 in FIG. 6 denotes a hardened material of the hydrous water absorbent polymer dispersed ultraviolet curable resin composition.

As seen from Examples 1 to 3 and Comparative example 1 shown in Table 1, the molded bodies having the high moisture contents are produced by lowering the water absorption rates of the ultraviolet curable resin compositions. The resultant molded bodies can be high in porosity rate and have the uniform micro pores. Also, as seen from Examples 2 and 3 shown in Table 1, when the viscosity of the ultraviolet curable resin compositions is high, the maximum moisture content thereof is low in comparison to Example 1. Further, from FIGS. 5 and 6, it can be understood that the adding of the non-ionic surfactant allows the micro dispersion of the hydrous water absorbent polymer, resulting in the hydrous water absorbent polymer dispersed ultraviolet curable resin composition having the plural pores 4 with the small pore diameters.

As apparent from the above description, the above embodiments and Examples are given as one typical example of the hydrous water absorbent polymer dispersed ultraviolet curable resin composition, and the invention should, of course, not particularly be limited to these embodiments and Examples, but various design alterations may be made within the appended claims.

What is claimed is:

1. A hydrous water absorbent polymer dispersed ultraviolet curable resin composition, comprising:
an ultraviolet curable resin composition; and
a hydrous water absorbent polymer swollen by water beforehand, and dispersed in the ultraviolet curable resin composition so that the hydrous water absorbent polymer dispersed ultraviolet curable resin composition has a moisture content of not less than 50 percent,
wherein a water absorption rate of the ultraviolet curable resin composition is not more than 2 percent.

2. The hydrous water absorbent polymer dispersed ultraviolet curable resin composition according to claim 1, wherein
the ultraviolet curable resin composition comprises a polyether based urethane(meth)acrylate oligomer having a water absorption rate of not more than 2 percent, a hydrophobic monomer, and a photoinitiator, and
the ultraviolet curable resin composition comprises the oligomer of 50 to 80 weight percent, the hydrophobic monomer of 20 to 50 weight percent, and the photoinitiator of 1 to 10 weight percent, and
the ultraviolet curable resin composition has a viscosity of 1 to 10 Pa·s at 25 degrees Celsius.

3. The hydrous water absorbent polymer dispersed ultraviolet curable resin composition according to claim 1, further comprising
a non-ionic surfactant added to the ultraviolet curable resin composition.

4. An insulated electric wire, comprising:
a conductor; and
an insulating layer comprising the hydrous water absorbent polymer dispersed ultraviolet curable resin composition according to claim 1, which coats a perimeter of the conductor, is cured, and subsequently heated to remove moisture from the resin composition.

5. The insulated electric wire according to claim 4, wherein
the insulating layer is not more than 200 μm in thickness, and is 50 to 70 percent in porosity rate.

6. A multilayer sheathed cable, comprising:
the insulated electric wire according to claim 4; and
a skin layer on a periphery of the insulated electric wire.

7. A method for producing an insulated electric wire, comprising:
coating a perimeter of a conductor with the hydrous water absorbent polymer dispersed ultraviolet curable resin composition according to claim 1;
curing the resin composition to form an insulating layer; and
subsequently heating the resin composition to remove moisture from the hydrous water absorbent polymer in the insulating layer, to thereby form pores in the insulating layer.

8. The method according to claim 7, wherein
the heating comprises a microwave heating.

9. A coaxial cable, comprising:
the insulated electric wire according to claim 4; and
a shielding member on a periphery of the insulated electric wire, the shielding member comprising a metal.
